(19) United States
(12) Patent Application Publication
(10) Pub. No.: US 2014/0305231 A1
(43) Pub. Date: Oct. 16, 2014

(54) KEYBOARD TESTING MACHINE

(71) Applicant: Quanta Computer Inc., Taoyuan Shien (TW)

(72) Inventors: Lung-Chiang CHU, Taipei City (TW); Hung-Wei WANG, New Taipei City (TW); Chin-Shun LAI, Taipei City (TW)

(73) Assignee: Quanata Computer Inc., Taoyuan Shien (TW)

(21) Appl. No.: 14/070,321

(22) Filed: Nov. 1, 2013

(30) Foreign Application Priority Data
Apr. 15, 2013 (TW) 102113325

(51) Int. Cl. G01M 99/00

(52) U.S. Cl. CPC G01M 99/007
USPC 73/865.3

(57) ABSTRACT

A keyboard testing machine for testing a keyboard of an electronic apparatus is apparatus. The electronic apparatus is carried on a conveyor. The keyboard testing machine includes a rack, a 3D movement apparatus, a linear encoder, a first driving module, and a pressing module. A first slide rail of the rack is parallel to the conveying direction of the conveyor. The 3D movement apparatus is slidably disposed on the first slide rail. The linear encoder is used to detect the conveying speed of the conveyor. The first driving module is disposed on the rack for driving the 3D movement apparatus to move along the first slide rail with the conveying speed. The pressing module is operatively connected to the 3D movement apparatus. The 3D movement apparatus makes the pressing module press the keyboard, and moves the pressing module along a pressing path relative to the keyboard.

### CROSS-REFERNECE TO RELATED APPLICATIONS

This application claims priority to Taiwan Application Serial Number 102113325, filed Apr. 15, 2013, which is herein incorporated by reference.

### FIELD OF THE INVENTION

The present disclosure relates to a keyboard testing machine, and more particularly, to a keyboard testing machine for testing keyboards of notebook computers.

### BACKGROUND

In the present information-oriented society, keyboards almost are indispensable input devices for electronic apparatuses, such as personal computers, notebook computers, calculators, telephones, etc. Therefore, whether or not a keyboard correctly functions affects signals thereby inputted into an electronic apparatus, so it is necessary to completely test to make sure that the functions of the keyboard all work perfectly.

Currently in the industry, keyboards are tested by a manually or a machinery testing approach. The manually testing approach is to press keyswitches of keyboards one by one by a large number of workers. However, in the manually testing approach there exists shortages of: (1) requiring operators to interact with testing software; (2) taking long test time to test at low efficiency; (3) requiring repeatedly testing for the operators may incorrectly press the respective keyswitches; and (4) occurring slowdowns of the operators.

Accordingly, it is an important issue of providing a keyboard testing machine to automatically test keyboards of electronic apparatuses so as to improve testing accuracy and efficiency.

### SUMMARY

The disclosure provides a keyboard testing machine for testing a keyboard of an electronic apparatus. The electronic apparatus is carried on a conveyer. The keyboard testing machine includes a rack, a 3D movement apparatus, a linear encoder, a first driving module, and a pressing module. The rack is located over the conveyer and has a first slide rail. The first slide rail is parallel to a conveying direction of the conveyer. The 3D movement apparatus is slidably disposed on the first slide rail. The linear encoder is adjacent to the conveyer, and is used to detect a conveying speed of the conveyer. The first driving module is disposed on the rack and electrically connected to the linear encoder, and is used to drive the 3D movement apparatus to move relative to the rack along the first slide rail with the conveying speed. The pressing module is operatively connected to the 3D movement apparatus. The 3D movement apparatus makes the pressing module press the keyboard, and moves the pressing module along a pressing path relative to the keyboard.

In an embodiment of the disclosure, the 3D movement apparatus includes a first sliding base, a second sliding base, and a second driving module. The first sliding base is slidably disposed on the first slide rail and has a second slide rail. The second slide rail is parallel to the first slide rail. The second sliding base is slidably disposed on the second slide rail. The second driving module is disposed on the first sliding base, and is used to drive the second sliding base to move relative to the first sliding base along the second slide rail, so as to make the pressing module move along the conveying direction.

In an embodiment of the disclosure, the second sliding base has a third slide rail disposed along a horizontal direction that is parallel to the conveyer and perpendicular to the conveying direction. The 3D movement apparatus includes a third sliding base and a third driving module. The third sliding base is slidably disposed on the third slide rail. The third driving module is disposed on the second sliding base, and is used to drive the third sliding base to move relative to the second sliding base along the third slide rail, so as to make the pressing module move along the horizontal direction.

In an embodiment of the disclosure, the third sliding base has a fourth slide rail disposed along a vertical direction that is perpendicular to the conveyer. The 3D movement apparatus includes a fourth sliding base and a fourth driving module. The fourth sliding base is slidably disposed on the fourth slide rail. The pressing module is fixed to the fourth sliding base. The fourth driving module is disposed on the third sliding base, and is used to drive the fourth sliding base to move relative to the third sliding base along the fourth slide rail, so as to make the pressing module move along the vertical direction.

In an embodiment of the disclosure, the keyboard testing machine further includes a reader and a processor. The reader is adjacent to the conveyer, and is used to read a barcode on the electronic apparatus. The processor is electrically connected to the reader, the second driving module, the third driving module, and the fourth driving module, and is used to drive the second driving module, the third driving module, and the fourth driving module according to the barcode.

In an embodiment of the disclosure, the processor drives the second driving module, the third driving module, and the fourth driving module according to machine displacement parameters corresponding to the barcode, so as to move the pressing module to an initial pressing position.

In an embodiment of the disclosure, the keyboard testing machine further includes a light sensor. The light sensor is adjacent to the conveyer and electrically connected to the processor, and is used to generate a blocking signal when the electronic apparatus passes by. The processor drives the second driving module, the third driving module, and the fourth driving module according to the blocking signal and the barcode.

In an embodiment of the disclosure, the processor drives the second driving module, the third driving module, and the fourth driving module according to a pressing path parameter corresponding to the barcode, so as to make the pressing module move relative to the keyboard along the pressing path from the initial pressing position.

In an embodiment of the disclosure, the pressing module includes a first rod, a guiding block, a second rod, a stopper, a pressing member, and a spring. Two ends of the first rod are respectively connected to the fourth sliding base and the guiding block. The second rod passes through the guiding block and is parallel to the first rod. Two ends of the second rod are respectively connected to the stopper and pressing member. The pressing member is used to press the keyboard. The spring is sleeved onto the second rod and compressed between the guiding block and the pressing member.

In an embodiment of the disclosure, the pressing block includes a rubber wheel for pressing the keyboard.

Accordingly, the keyboard testing machine of the disclosure use the 3D movement apparatus to drive the pressing module to press the keyboard of the electronic apparatus in a sliding manner, so as to obtain the effect of saving manpower. The keyboard testing machine of the disclosure uses the reader to read the barcode on the electronic apparatus and thus recognize the type of the electronic apparatus, so as to accurately adjust the horizontal position and the vertical position of the pressing module relative to the keyboard by controlling the 3D movement apparatus according to the type of the electronic apparatus. Furthermore, the keyboard testing machine of the disclosure uses the linear encoder to detect the conveying speed of the conveyer, and thus makes the 3D movement apparatus to move together with the electronic apparatus with the same speed, so as to simplify the process that the 3D movement apparatus drives the pressing module to horizontally move. Moreover, the keyboard testing machine use the light sensor to detect whether the electronic apparatus on the conveyer passes by, so as to drive the 3D movement apparatus to move the pressing module when the electronic apparatus passes by the light sensor, and thus achieve the purpose of automatically testing the keyboard.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a keyboard testing machine according to an embodiment of the disclosure;

FIG. 2 is a partial perspective view of the keyboard testing machine in FIG. 1;

FIG. 3 is a partial front view of the pressing module in FIG. 2; and

FIG. 4 is a circuit diagram of the keyboard testing machine according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

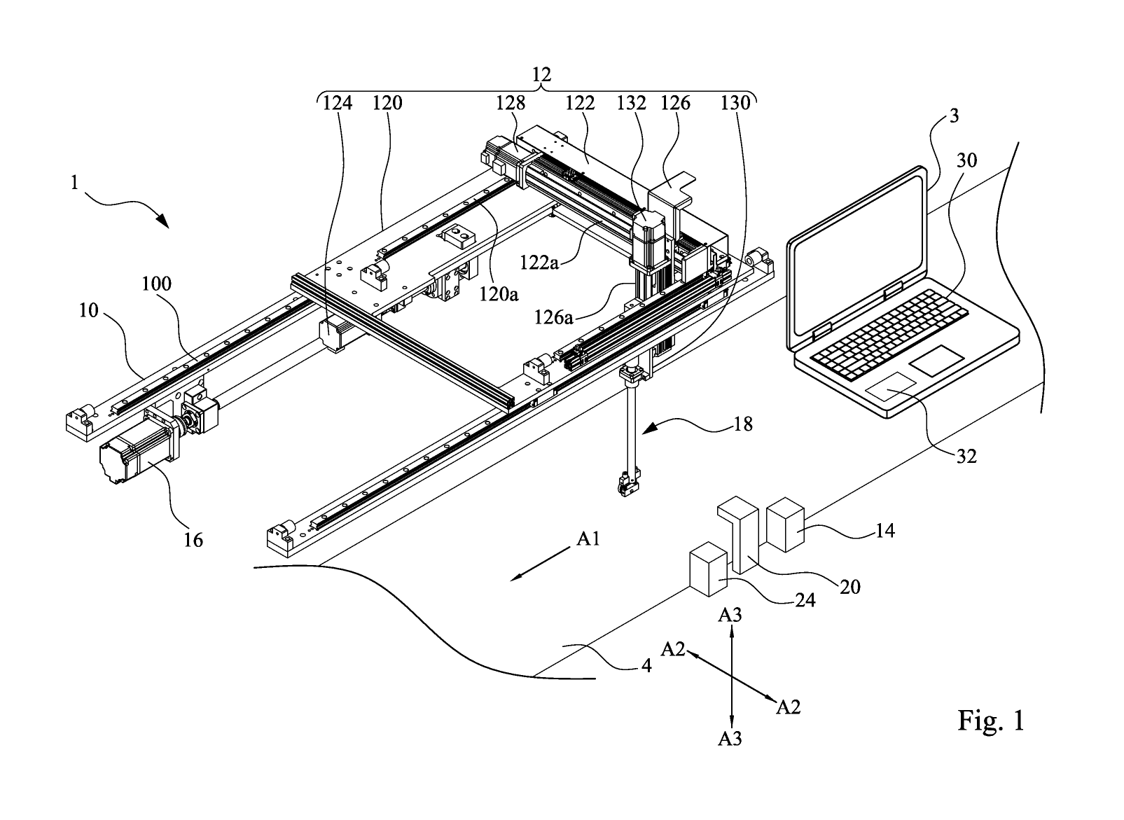

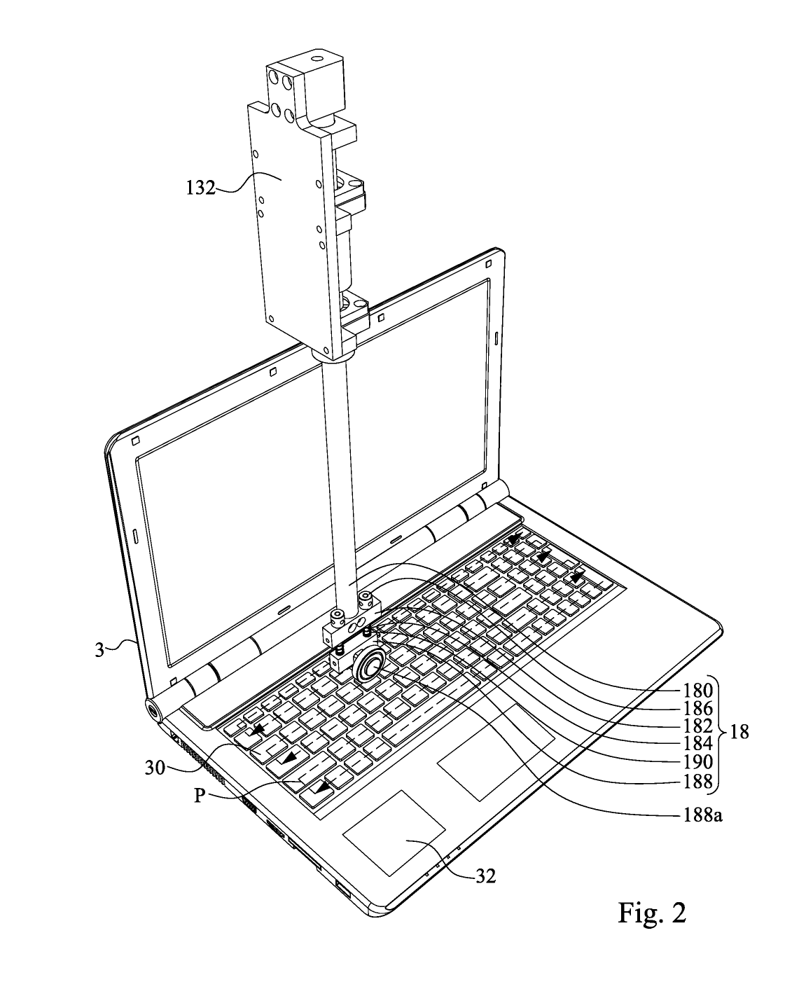

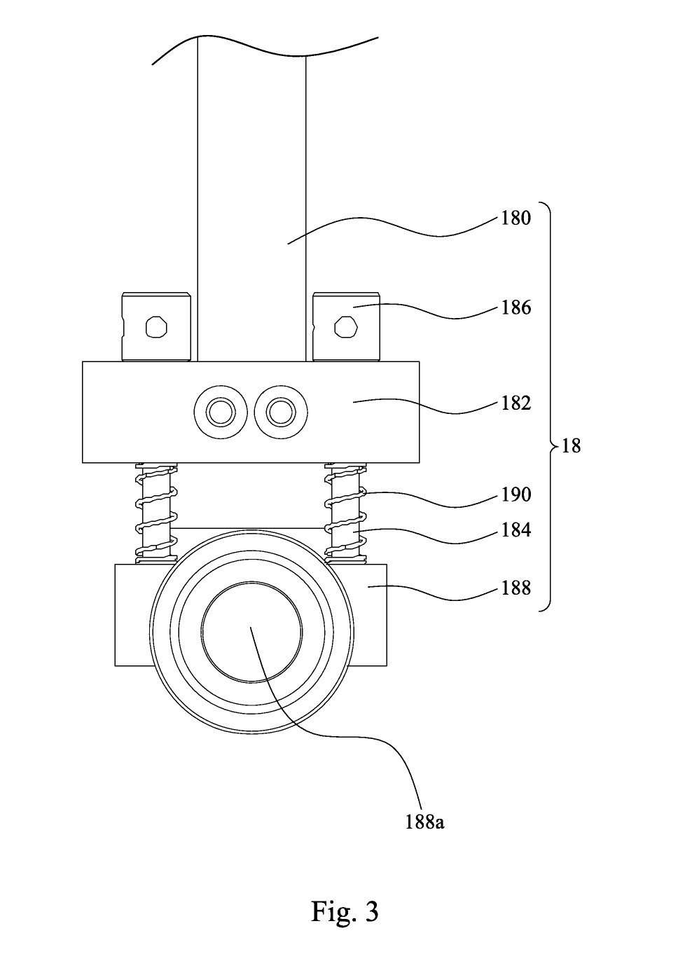

FIG. 1 is a perspective view of a keyboard testing machine 1 according to an embodiment of the disclosure. FIG. 2 is a partial perspective view of the keyboard testing machine 1 in FIG. 1. FIG. 3 is a partial front view of the pressing module 18 in FIG. 2.

As shown in FIG. 1, FIG. 2, and FIG. 3, the keyboard testing machine 1 is used to test a keyboard 30 of an electronic apparatus 3. The electronic apparatus 3 is carried on a conveyer 4. In the embodiment of the disclosure, the electronic apparatus 3 is a notebook computer, but the disclosure is not limited in this regard. As long as an electronic apparatus has a keyboard (or just an individual keyboard), the keyboard testing machine 1 can be used to test.

The keyboard testing machine 1 includes a rack 10, a 3D movement apparatus 12, a linear encoder 14, a first driving module 16, and a pressing module 18. The rack 10 of the keyboard testing machine 1 is located over the conveyer 4 and has a first slide rail 100. The first slide rail 100 of the rack 10 is parallel to a conveying direction A1 of the conveyer 4. The 3D movement apparatus 12 of the keyboard testing machine 1 is slidably disposed on the first slide rail 100 of the rack 10. The linear encoder 14 of the keyboard testing machine 1 is adjacent to the conveyer 4, and is used to detect a conveying speed of the conveyer 4. The first driving module 16 of the keyboard testing machine 1 is disposed on the rack 10 and electrically connected to the linear encoder 14. Hence, the first driving module 16 is capable of driving the 3D movement apparatus 12 to move relative to the rack 10 along the first slide rail 100 with the conveying speed. The pressing module 18 of the keyboard testing machine 1 is operatively connected to the 3D movement apparatus 12. The 3D movement apparatus 12 of the keyboard testing machine 1 makes the pressing module 18 press the keyboard 30 of the electronic apparatus 3, and moves the pressing module 18 along a pressing path P (as shown in FIG. 2) relative to the keyboard 30.

Therefore, the keyboard testing machine 1 of the disclosure can use the linear encoder 14 to detect the conveying speed of the conveyer 4, and thus makes the 3D movement apparatus 12 to move together with the electronic apparatus 3 with the same speed (i.e., there is no relative displacement between the 3D movement apparatus 12 and the electronic apparatus 3), so as to simplify the process that the 3D movement apparatus 12 drives the pressing module 18 to horizontally move.

In other words, the keyboard testing machine 1 of the disclosure remove the relative displacement between the 3D movement apparatus 12 and the electronic apparatus 3 by making the 3D movement apparatus 12 to move together with the electronic apparatus 3 with the same speed, so that the process that the 3D movement apparatus 12 drives the pressing module 18 to horizontally move can be simplified.

In the embodiment of the disclosure, the pressing path P that the 3D movement apparatus 18 of the keyboard testing machine 1 moves the pressing module 18 relative to the keyboard 30 starts sequentially from the most right keyswitch to the most left keyswitch at the lowest row (i.e., the first row) of the keyboard 30, from the most left keyswitch to the most right keyswitch at the second row, from the most right keyswitch to the most left keyswitch at the third row, from the most left keyswitch to the most right keyswitch at the fourth row, from the most right keyswitch to the most left keyswitch at the fifth row, and finally from the most left keyswitch to the most right keyswitch at the sixth row (as shown in FIG. 2), so as to press all of the keyswitches on the keyboard 30.

However, the disclosure is not limited in this regard. In practice, the pressing path P that the 3D movement apparatus 18 of the keyboard testing machine 1 moves the pressing module 18 relative to the keyboard 30 can be adjusted as needed (e.g., in order to comply with the required specifications).

The descriptions about how the 3D movement apparatus 12 of the keyboard testing machine 1 make the pressing module 18 move and press the keyboard 30 of the electronic apparatus 3 in a sliding manner are explained in the following embodiment.

As shown in FIG. 1, the 3D movement apparatus 12 of the keyboard testing machine 1 includes a first sliding base 120, a second sliding base 122, and a second driving module 124. The first sliding base 120 of the 3D movement apparatus 12 is slidably disposed on the first slide rail 100 of the rack 10 and has a second slide rail 120a. The second slide rail 120a of the first sliding base 120 is parallel to the first slide rail 100 of the rack 10. The second sliding base 122 of the 3D movement apparatus 12 is slidably disposed on the second slide rail 120a of the first sliding base 120. The second driving module 124 of the 3D movement apparatus 12 is disposed on the first sliding base 120, and is used to drive the second sliding base 122 to move relative to the first sliding base 120 along the second slide rail 120a, so as to make the pressing module 18 move along the conveying direction A1.

In the embodiment of the disclosure, the second sliding base 122 of the 3D movement apparatus 12 has a third slide rail 122a. The third slide rail 122a of the second sliding base 122 is disposed along a horizontal direction A2 that is parallel to the conveyer 4 and perpendicular to the conveying direction A1. The 3D movement apparatus 12 further includes a third sliding base 126 and a third driving module 128. The third sliding base 126 of the 3D movement apparatus 12 is slidably disposed on the third slide rail 122a of the second sliding base 122. The third driving module 128 of the 3D movement apparatus 12 is disposed on the second sliding base 122, and is used to drive the third sliding base 126 to move relative to the second sliding base 122 along the third slide rail 122a, so as to make the pressing module 18 move along the horizontal direction A2.

In the embodiment of the disclosure, the third sliding base 126 of the 3D movement apparatus 12 has a fourth slide rail 126a. The fourth slide rail 126a of the third sliding base 126 is disposed along a vertical direction A3 that is perpendicular to the conveyer 4 (i.e., perpendicular to the conveying direction A1 and the horizontal direction A2). The 3D movement apparatus 12 further includes a fourth sliding base 130 and a fourth driving module 132. The fourth sliding base 130 of the 3D movement apparatus 12 is slidably disposed on the fourth slide rail 126a of the third sliding base 126. The pressing module 18 is fixed to the fourth sliding base 130 of the 3D movement apparatus 12. The fourth driving module 132 of the 3D movement apparatus 12 is disposed on the third sliding base 126, and is used to drive the fourth sliding base 130 to move relative to the third sliding base 126 along the fourth slide rail 126a, so as to make the pressing module 18 move along the vertical direction A3.

Hence, the keyboard testing machine 1 of the disclosure is capable of adjusting the horizontal position and the vertical position of the pressing module 18 relative to the keyboard 30 by using the 3D movement apparatus 12 disclosed above.

However, the disclosure is not limited in this regard. In practice, the direction along which the second slide rail 120a of the first sliding base 120 is disposed, the direction along which the third slide rail 122a of the second sliding base 122 is disposed, and the direction along which the fourth slide rail 126a of the third sliding base 126 is disposed are not perpendicular to each other, and other three-dimensional coordinate systems can be used.

In the embodiment of the disclosure, the first driving module 16 of the keyboard testing machine 1 and the second driving module 124, the third driving module 128, and the fourth driving module 132 of the 3D movement apparatus 12 can be linear guideways or constituted by screws and nut blocks.

As shown in FIG. 2 and FIG. 3, the pressing module 18 of the keyboard testing machine 1 includes a first rod 180, a guiding block 182, two second rods 184, a stopper 186, a pressing member 188, and two springs 190. Two ends of the first rod 180 of the pressing module 18 are respectively connected to the fourth sliding base 130 of the 3D movement apparatus 12 and the guiding block 182. The second rods 184 of the pressing module 18 pass through the guiding block 182 and are parallel to the first rod 180. The guiding block 182 of the pressing module 18 is used to guide the second rods 184 to linearly slide. Two ends of each of the second rods 184 of the pressing module 18 are respectively connected to the stopper 186 and pressing member 188. The pressing member 188 is used to press the keyboard 30 of the electronic apparatus 3. The springs 190 are respectively sleeved onto the second rods 184 and compressed between the guiding block 182 and the pressing member 188.

The stopper 186, the second rods 184, and the pressing member 188 of the pressing module 18 are fixed to each other, and the second rods 184 are guided by the guiding block 182, so during the period that the pressing member 188 of the pressing module 18 presses the keyboard 30 of the electronic apparatus 3, the stopper 186, the second rods 184, and the pressing member 188 linearly move relative to the guiding block 182, and the springs 190 that are compressed between the guiding block 182 and the pressing member 188 can achieve the effects of cushioning the pressing force of the pressing module 18 and the reaction force of the keyboard 30.

In order to further cushion the impact between the pressing module 14 and the keyboard 30 of the electronic apparatus 3, in the embodiment of the disclosure, the pressing member 188 of the pressing module 18 includes a rubber wheel 188a of which the value of Shore hardness is about 60 degrees, so as to press the keyboard 30, but the disclosure is not limited in this regard.

In the embodiment of the disclosure, the number of the second rods 184 of the pressing module 18 is two, but the disclosure is not limited in this regard and can be adjusted as needed.

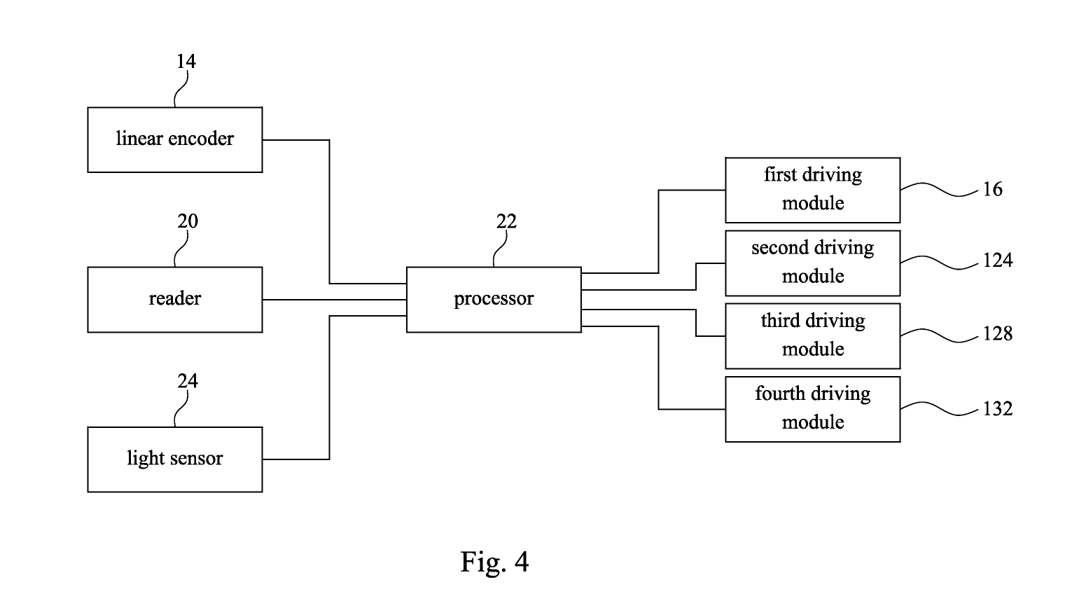

FIG. 4 is a circuit diagram of the keyboard testing machine 1 according to an embodiment of the disclosure.

As shown in FIG. 4 with reference to FIG. 1, the keyboard testing machine 1 further includes a processor 22. The processor 22 of the keyboard testing machine 1 is electrically connected to the linear encoder 14 and the first driving module 16, so as to make the 3D movement apparatus 12 move together with the electronic apparatus 3 according to the conveying speed detected by the linear encoder 16.

Furthermore, the keyboard testing machine 1 further includes a reader 20. The reader 20 of the keyboard testing machine 1 is adjacent to the conveyer 4, and is used to read a barcode 32 on the electronic apparatus 3. The processor 22 of the keyboard testing machine 1 is further electrically connected to the reader 20 and the second driving module 124, the third driving module 128, and the fourth driving module 132 of the 3D movement apparatus 12, and is used to drive the second driving module 124, the third driving module 128, and the fourth driving module 132 according to the barcode 32.

In an embodiment of the disclosure, the processor 22 of the keyboard testing machine 1 is disposed in an industrial computer (not shown), and the industrial computer includes a database (not shown) for recoding machine displacement parameters (including horizontal movement parameters and vertical movement parameters) of different types of electronic apparatuses. Hence, when the reader 20 reads the barcode 32 on the electronic apparatus 3, the industrial computer recognizes the type of the electronic apparatus 3, and makes the processor 22 drive the second driving module 124, the third driving module 128, and the fourth driving module 132 according to the machine displacement parameters corresponding to the electronic apparatus 3, so as to accurately move the pressing module 18 to an initial position over the keyboard 30 of the electronic apparatus 3 and then prepare to perform testing processes.

That is, the keyboard testing machine 1 of the disclosure is capable of using the reader 20 to read the barcode 32 on the electronic apparatus 3 and thus recognize the type of the electronic apparatus 3, so as to accurately adjust the horizontal position and the vertical position of the pressing module 18 relative to the keyboard 30 by controlling the 3D movement apparatus 12 according to the type of the electronic apparatus 3.

As shown in FIG. 1 and FIG. 4, the keyboard testing machine 1 further includes a light sensor 24. The light sensor 24 of the keyboard testing machine 1 is adjacent to the conveyer 4 and electrically connected to the processor 22, and is used to generate a blocking signal when the electronic apparatus 3 passes by. The processor 22 of the keyboard testing machine 1 is capable of driving the second driving module 124, the third driving module 128, and the fourth driving module 132 further according to the blocking signal generated by the light sensor 24 and the barcode 32.

In an embodiment of the disclosure, the database of the industrial computer records pressing path parameters corresponding to different types of electronic apparatus. Hence, when the light sensor 24 generates the blocking signal, the industrial computer immediately drives the second driving module 124, the third driving module 128, and the fourth driving module 132 according to the pressing path parameter corresponding to the electronic apparatus 3 by the processor 22, so as to move the pressing module 18 relative to the keyboard 30 of the electronic apparatus 1 from the initial position along the pressing path P and thus achieve the purpose of automatically testing the keyboard 30.

According to the foregoing recitations of the embodiments of the disclosure, it can be seen that the keyboard testing machine of the disclosure use the 3D movement apparatus to drive the pressing module to press the keyboard of the electronic apparatus in a sliding manner, so as to obtain the effect of saving manpower. The keyboard testing machine of the disclosure uses the reader to read the barcode on the electronic apparatus and thus recognize the type of the electronic apparatus, so as to accurately adjust the horizontal position and the vertical position of the pressing module relative to the keyboard by controlling the 3D movement apparatus according to the type of the electronic apparatus. Furthermore, the keyboard testing machine of the disclosure uses the linear encoder to detect the conveying speed of the conveyer, and thus makes the 3D movement apparatus to move together with the electronic apparatus with the same speed, so as to simplify the process that the 3D movement apparatus drives the pressing module to horizontally move. Moreover, the keyboard testing machine use the light sensor to detect whether the electronic apparatus on the conveyer passes by, so as to drive the 3D movement apparatus to move the pressing module when the electronic apparatus passes by the light sensor, and thus achieve the purpose of automatically testing the keyboard.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A keyboard testing machine for testing a keyboard of an electronic apparatus being carried on a conveyer, the keyboard testing machine comprising:
a rack located over the conveyer and having a first slide rail, wherein the first slide rail is parallel to a conveying direction of the conveyer;
a 3D movement apparatus slidably disposed on the first slide rail;
a linear encoder, adjacent to the conveyer, for detecting a conveying speed of the conveyer;
a first driving module, disposed on the rack and electrically connected to the linear encoder, for driving the 3D movement apparatus to move relative to the rack along the first slide rail with the conveying speed; and
a pressing module operatively connected to the 3D movement apparatus, wherein the 3D movement apparatus makes the pressing module press the keyboard, and moves the pressing module along a pressing path relative to the keyboard.

2. The keyboard testing machine of claim 1, wherein the 3D movement apparatus comprises:
a first sliding base slidably disposed on the first slide rail and having a second slide rail, wherein the second slide rail is parallel to the first slide rail;
a second sliding base slidably disposed on the second slide rail; and
a second driving module, disposed on the first sliding base, for driving the second sliding base to move relative to the first sliding base along the second slide rail, so as to make the pressing module move along the conveying direction.

3. The keyboard testing machine of claim 2, wherein the second sliding base has a third slide rail disposed along a horizontal direction that is parallel to the conveyer and perpendicular to the conveying direction, and the 3D movement apparatus comprises:
a third sliding base slidably disposed on the third slide rail; and
a third driving module, disposed on the second sliding base, for driving the third sliding base to move relative to the second sliding base along the third slide rail, so as to make the pressing module move along the horizontal direction.

4. The keyboard testing machine of claim 3, wherein the third sliding base has a fourth slide rail disposed along a vertical direction that is perpendicular to the conveyer, and the 3D movement apparatus comprises:
a fourth sliding base slidably disposed on the fourth slide rail, wherein the pressing module is fixed to the fourth sliding base; and
a fourth driving module, disposed on the third sliding base, for driving the fourth sliding base to move relative to the third sliding base along the fourth slide rail, so as to make the pressing module move along the vertical direction.

5. The keyboard testing machine of claim 4, further comprising:
a reader, adjacent to the conveyer, for reading a barcode on the electronic apparatus; and
a processor, electrically connected to the reader, the second driving module, the third driving module, and the fourth driving module, for driving the second driving module, the third driving module, and the fourth driving module according to the barcode.

6. The keyboard testing machine of claim 5, wherein the processor drives the second driving module, the third driving module, and the fourth driving module according to machine displacement parameters corresponding to the barcode, so as to move the pressing module to an initial pressing position.

7. The keyboard testing machine of claim 6, further comprising:
a light sensor, adjacent to the conveyer and electrically connected to the processor, for generating a blocking signal when the electronic apparatus passes by, wherein the processor drives the second driving module, the third driving module, and the fourth driving module according to the blocking signal and the barcode.

8. The keyboard testing machine of claim 7, wherein the processor drives the second driving module, the third driving module, and the fourth driving module according to a pressing path parameter corresponding to the barcode, so as to make the pressing module move relative to the keyboard along the pressing path from the initial pressing position.

9. The keyboard testing machine of claim 1, wherein the pressing module comprises:
a first rod of which an end is connected to the fourth sliding base;
a guiding block connected to another end of the first rod;
a second rod passing through the guiding block and parallel to the first rod;
a stopper connected to an end of the second rod;
a pressing member, connected to another end of the second rod, for pressing the keyboard; and
a spring sleeved onto the second rod and compressed between the guiding block and the pressing member.

10. The keyboard testing machine of claim 9, wherein the pressing member comprises a rubber wheel for pressing the keyboard.
